(19) United States
(12) Patent Application Publication
(10) Pub. No.: US 2023/0196128 A1
(43) Pub. Date: Jun. 22, 2023

(54) INFORMATION PROCESSING METHOD, APPARATUS, ELECTRONIC DEVICE, STORAGE MEDIUM AND PROGRAM PRODUCT

(71) Applicant: Samsung Electronics Co., Ltd., Suwon-si (KR)

(72) Inventors: Yimeng ZHUANG, Beijing (CN); Jing ZHANG, Beijing (CN); Mei TU, Beijing (CN)

(21) Appl. No.: 18/168,234

(22) Filed: Feb. 13, 2023

Related U.S. Application Data
(63) Continuation of application No. PCT/KR2022/013404, filed on Sep. 7, 2022.

(30) Foreign Application Priority Data
Sep. 7, 2021 (CN) 202111046095.7
Jun. 14, 2022 (CN) 202210674662.1

(51) Int. Cl. G06N 5/02; G06F 40/30; G06F 40/284; G06F 40/151

(52) U.S. Cl. CPC G06N 5/02; G06F 40/30; G06F 40/284; G06F 40/151; G06V 10/82

(57) ABSTRACT

An information processing method, an apparatus, an electronic device, a computer readable storage medium and a computer program product are provided. The method includes performing a fast Fourier transform-based feature crossing process on at least two target vectors in an input sequence of target information to obtain an output sequence of target information, and performing a feature perception process on the output sequence of the target information to obtain a target sequence of the target information, wherein the target sequence represents semantic information of each target object in the target information correlated to other target objects in the target information.

### CROSS-REFERENCE TO RELATED APPLICATION

This application is a continuation application, claiming priority under § 365(c), of an International application No. PCT/KR2022/013404, filed on Sep. 7, 2022, which is based on and claims the benefit of a Chinese Provisional patent application number 202111046095.7, filed on Sep. 7, 2021, in the Chinese National Intellectual Property Administration Patent Office, and of a Chinese Complete patent application number 202210674662.1, filed on Jun. 14, 2022, in the Chinese National Intellectual Property Administration, the disclosure of each of which is incorporated by reference herein in its entirety.

### BACKGROUND

### 1. Field

The disclosure relates to the field of artificial intelligence technology. More particularly, the disclosure relates to an information processing method, an apparatus, an electronic device, a computer readable storage medium and a computer program product.

### 2. Description of the Related Art

In deep learning, for the information to be processed, such as texts, images, audios, in order to better determine the semantic information of each object vector in the information, in addition to the semantic information of each object vector itself, it is also necessary to determine the contextual semantic information corresponding to each object vector in the information.

In the prior art, global information about the object needs to be perceived in the processing of contextual semantic information, however, the high computational complexity and computational amount of global information perception leads to very low efficiency in the processing of the information and very low accuracy of the semantic information determined.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an information processing method, an apparatus, and electronic device, a computer readable storage medium and a computer program product, and can address issues of high computational complexity and large computational amount in information processing in the related art.

Additional aspects will be set forth in part in the description which follows and, in part, will be apparent from the description, or may be learned by practice of the presented embodiments.

In accordance with an aspect of the disclosure, an information processing method is provided. The method includes performing a fast Fourier transform-based feature crossing process on at least two target vectors in an input sequence of target information to obtain an output sequence of the target information, and performing a feature perception process on the output sequence of the target information to obtain a target sequence of the target information, wherein the target sequence represents semantic information of each target object in the target information correlated to other target objects in the target information.

In accordance with another aspect of the disclosure, an information processing apparatus is provided. The apparatus includes a crossing module configured to perform a fast Fourier transform-based feature crossing process on at least two target vectors in an input sequence of target information to obtain an output sequence of the target information, and an attention module configured to perform a feature perception process on the output sequence of the target information to obtain a target sequence of the target information, wherein the target sequence represents semantic information of each target object in the target information correlated to other target objects in the target information.

In accordance with another aspect of the disclosure, an electronic device is provided. The electronic device includes one or more processors, a memory, and one or more computer programs, wherein the one or more computer programs are stored in the memory and configured to be executed by the one or more processors, the one or more computer programs are configured for performing the above information processing method.

In accordance with another aspect of the disclosure, at least one non-transitory computer readable storage medium is provided. The at least one non-transitory computer readable storage medium includes storing computer instructions, the computer instructions, when running on a computer, cause the computer to perform the above information processing method.

According to an aspect of disclosure, a computer program product is provided. The computer program product includes computer programs or instructions that, when executed by the processors, implement operations of the above information processing method.

The beneficial effects brought by the technical solutions provided by the embodiments of the disclosure are included below.

The disclosure provides an information processing method, an apparatus, and electronic device, a computer readable storage medium and a computer program product. Specifically, in the disclosure, an output sequence of target information can be obtained by performing a fast Fourier transform-based feature crossing process on at least two target vectors in an input sequence of the target information, wherein the target vector is also referred to as a hidden state, that is, the crossing of hidden states is implemented, and the relationship between a target vector and another target vector in the target information can be determined. A fully connected process at square level needs to be performed for the implementation of the crossing of hidden states in the related art, which have very high computational complexity. While the disclosure adopts a hidden state crossing method of fast Fourier transform, the crossing of hidden states can be implemented efficiently, which is beneficial to reduce the computational complexity and increase the processing efficiency. On this basis, the target sequence of the target information is obtained by performing a feature perception process on the output sequence of the target information. It is possible to effectively improve the accuracy of the semantic information of each target object the target information represented by the target sequence correlated to other target objects in the target information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of a flow of an information processing method according to an embodiment of the disclosure;

FIG. 2 is a schematic diagram of a flow of information processing according to an embodiment of the disclosure;

FIG. 3 is a schematic diagram of a crossing of hidden states according to an embodiment of the disclosure;

FIG. 4 is a schematic diagram of a flow for pooled hidden state crossing according to an embodiment of the disclosure;

FIG. 5 is a schematic diagram of a computation process for a predictable sparse attention mechanism according to an embodiment of the disclosure;

FIG. 6A is a schematic diagram of a flow of generating a predicted sparse attention matrix according to an embodiment of the disclosure;

FIG. 6B is a structural schematic diagram of a predicted sparse attention matrix according to an embodiment of the disclosure;

FIG. 7 is a schematic diagram of a flow for determining a context-aware vector according to an embodiment of the disclosure;

FIG. 8 is a schematic diagram of a processing process for an attention mechanism according to an embodiment of the disclosure;

FIG. 9 is a schematic structure diagram of an information processing apparatus according to an embodiment of the disclosure; and

FIG. 10 is a structural schematic diagram of an electronic device according to an embodiment of the disclosure.

Throughout the drawings, it should be noted that like reference numbers are used to depict the same or similar elements, features, and structures.

### DETAILED DESCRIPTION

The following description with references to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An ordinary person skilled in the art may understand that “a”, “an”, “said” and “this” may also refer to plural nouns, unless otherwise specifically stated. It should be further understood that the term “comprise/comprising” or “include/including” used in the embodiments of the disclosure refers that the corresponding features may be implemented as the presented features, information, data, operations, elements and/or components, but does not exclude that they are implemented as other features, information, data, operations, elements, components and/or combinations thereof supported in the art. It should be understood that, when an element is “connected to” or “coupled to” to another element, this element may be directly connected to or coupled to another element, or this element may be connected to another element through an intermediate element. Further, “connection” or “coupling” used herein may include wireless connection or wireless coupling. The term “and/or” used herein indicates at least one of the items defined by the term, for example “A and/or B” may be implemented as “A”, or as “B”, or as “A and B”.

In order to make the objectives, technical solutions and advantages of the disclosure clearer, the embodiments of the disclosure will be further described below in combination with the accompanying drawings.

The related art to which the disclosure pertains will be explained below.

Artificial intelligence (AI) is a theory, a method, a technique and an application system for using digital computers or machines controlled by digital computers to simulate, extend and expand human intelligence, perceive the environments, acquire knowledge and use the knowledge to obtain the best results. In other words, an artificial intelligence is a comprehensive technique of computer science which attempts to understand the essence of intelligence and produce a new kind of intelligent machine that can respond in a way similar to human intelligence. Artificial intelligence is to study the design principles and implementation methods of various intelligent machines, so that the machines have the functions of perception, reasoning and decision-making.

Artificial intelligence technology is a comprehensive discipline involving a wide range of fields, including both hardware level technology and software level technology. The base technologies of artificial intelligence generally include technologies, such as sensors, dedicated artificial intelligence chips, cloud computing, distributed storage, big data processing technology, operation/interaction systems and mechatronics. The software technology of artificial intelligence mainly includes several general tendencies, such as computer vision technology, voice processing technology, natural language processing technology as well as machine learning/deep learning. In the disclosure, the natural language processing technology may be involved.

Natural language processing (NLP) is an important direction in the field of computer science and artificial intelligence. The natural language processing is conducting various theories and methods that enable effective communication between humans and computers using natural language. Natural language processing is a science that integrates linguistics, computer science and mathematics. Therefore, research in this filed will therefore involve natural language, i.e., the language that people use every day, and so it is closely linked to the study of linguistics. The natural language processing technology generally includes technologies, such as text processing, semantic understanding, machine translation, Robotics Q & A and knowledge graph.

The technical problem of how to determine the semantic information between a certain target vector and another target vector when processing the information to be processed in natural language processing can be addressed in this application. Specifically, for example, for a given sentence, where each word can be regarded as a token, a vector representation of each token is obtained after a word vector query and these vectors constitute a sequence of word vectors for the sentence. The vectors at this point are isolated word vectors, i.e., the vector representation of each token is independent of the other tokens in the sentence, the problem to be addressed is how to obtain a vector representation of each word correlated to the other tokens in the sentence, i.e., context modelling.

Hereinafter, the sentence processing is taken as an example to illustrate the method in which the contextual semantic information that each word vector corresponds to in the sentence in the related art.

At present, a recurrent neural network, a convolutional neural network, and a Transformer model are mainly used to address the above technical problems. Among them, the recurrent neural network achieves unidirectional or bidirectional context modelling by updating memory units word by word, but it has obvious disadvantages, that is, the models are difficult to parallelize, so the calculation speed is slow and it is difficult to build large-scale models. Among them, the convolutional neural network continuously perceives local features through convolutional operations, and the awareness of long contexts is implemented by superimposing multiple layers, but the convolutional awareness of the context is local, so it requires a very many layers for long sequences to model global information, but the processing efficiency is very low. Among them, the Transformer model implements the global awareness for context by a self-attention mechanism. However, the computational complexity is squared correlated to the length of the sequence, that is, when the processing sequence increases by 10 times, the amount of computation required becomes 100 times greater.

From the above analysis of related technologies, it can be seen that for the global information perception, global information is compared with local information, the local information is information that can be derived through a small range of few words, whereas the global information needs to be derived by perceiving associations between words over a long span. Specifically, when perceiving global information, it is necessary to calculate the similarity of two tokens in a sentence, which causes the calculation complexity to be squared in relationship with the length of the sequence, which is not only computationally complex but also time-consuming In addition, due to the characteristics of the self-attention mechanism itself, as the depth of the model increases, as the rank of the feature matrix continues to decrease and the self-attention matrix becomes more and more similar, resulting in the deep model having difficulty in obtaining new information, which ultimately leads to a restricted perception mode of the model and the low accuracy rate of the model output.

In view of the at least one technical problems or aspects that need to be improved present in the related art as described above, the disclosure proposes an information processing method, an apparatus, an electronic device, a computer readable storage medium and a computer program product. Specifically, the disclosure adopts a hidden state crossing method of convolution of the fast Fourier transform, the pairwise crossing of hidden states can be implemented efficiently, which is beneficial to reduce the computational complexity and increase the processing efficiency. On this basis, it is possible to effectively improve the accuracy of the semantic information of each target object the target information correlated to other target objects.

The technical solutions in the embodiments of the disclosure and the technical effects achieved by the technical solutions in the disclosure will be explained below by describing several implementations. It is to be noted that the following implementations may refer to or learn from each other or be combined with each other, and the same terms, similar features and similar implementation operations in different implementations will not be repeated.

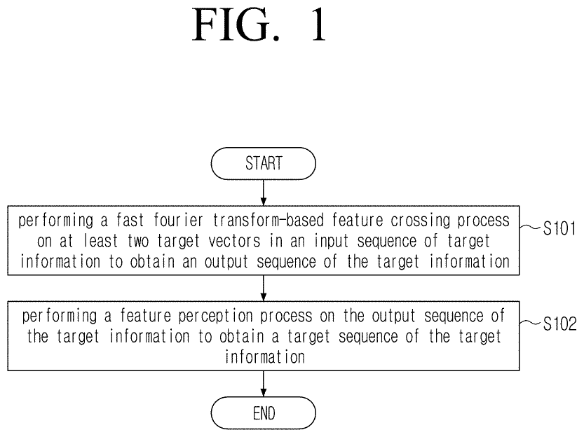

FIG. 1 is a schematic diagram of a flow of an information processing method according to an embodiment of the disclosure.

Referring to FIG. 1, an information processing method is provided in an embodiment of the disclosure, which illustrates schematic diagram of a flow of an information processing method provided in an embodiment of the disclosure, wherein the method can be executed by any electronic device, e.g., it can be a user terminal or a server, the user terminal can be a smartphone, a tablet computer, a laptop computer, a desktop computer, a smart speaker, a smart watch, on-vehicle equipment, or the like, and the server can be an independent physical server or a server cluster or distributed system consisting of multiple physical servers, and can be a cloud server for providing basic cloud computing services, such as cloud services, cloud database, cloud computing, cloud functions, cloud storage, network services, cloud communications, middleware services, domain name services, security services, a content delivery network (CDN), and big data and artificial intelligence platforms, but the disclosure is not limited to this.

More particularly, the information processing method may include the following operations S101-S102:

In operation S101, a fast Fourier transform-based feature crossing process is performed on at least two target vectors in an input sequence of target information to obtain an output sequence of the target information.

Specifically, the target information may be multimedia information, e.g., one of image, audio, and corpus, wherein the corpus may be words, phrases, sentences, fragments, articles, or the like. In embodiments of the disclosure, in order to better illustrate the various examples, explanation is made by taking processing on corpus, such as sentences, fragments, and articles as an example. For example, the target information may be a sentence “ [symbol] [symbol] ”.

Optionally, the target information may be obtained in different application scenarios based on different input sources, e.g., in a speech interaction scenario, the target information may be a particular command entered by the user's voice, e.g., in a semantic understanding scenario, the target information can be a particular sentence selected by the user in a particular article.

Wherein the input sequence of target information may be a vector sequence obtained by target vector transformation of the text corresponding to the target information using the pre-module, the physical meaning of the vector sequence is a mathematical characterization of the information semantic. In certain scenarios, a target vector can also be referred as a hidden state. An input sequence of target information includes assuming that the target information is “ [symbol] [symbol] ”, each target object (token) in the target information corresponds to a vector respectively, so that an input sequence [X₁X₂X₃X₄X₅X₆X₇X₈X₉X₁₀] is composed, e.g., “ [symbol] ” corresponds to the vector X₁, and “ [symbol] ” corresponds to the vector V², or the like.

Wherein the fast Fourier transform (FFT) is an efficient and fast calculating method that uses computers to calculate discrete Fourier transform (DFT). An embodiment of the disclosure adopts the FFT algorithm to reduce the computational complexity of the pairwise crossing of hidden states in the related art. In the subsequent embodiments of the disclosure, a processing logic for the crossing of hidden states based on convolution of the fast Fourier transform according to embodiments of the disclosure is illustrated below.

Wherein the crossing of hidden states is implemented by performing a fast Fourier transform-based feature crossing process on at least two target vectors in an input sequence of target information in operation S101. The crossing of hidden states is also referred to as combination of hidden states, a new feature xy is synthesized by multiplying a feature x with a feature y, and it is intended to combine two target vectors to obtain a higher-order representation of the features containing semantic dependency information.

Wherein the output sequence of the target information may be a vector sequence having the same length as the input sequence. It may be understood that the output sequence is a feature extraction of the input sequence that causes the semantic information of the target vector represented by the output sequence to change and serves as the base data for subsequent feature perception process, thereby improving the accuracy rate of the semantic information determined in the information processing of the embodiments of the disclosure.

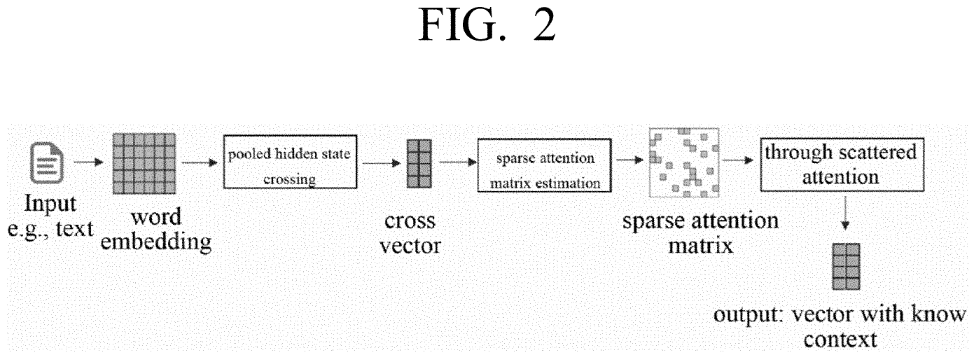

FIG. 2 is a schematic diagram of a flow of information processing according to an embodiment of the disclosure.

Referring to FIG. 2, the above operation S101 may perform an efficient algorithm for encoding and compressing the semantic dependencies of object (e.g., token) pairs by means of a pooled hidden state crossing module as shown in FIG. 2 to obtain an output sequence of the target information (the cross vector as shown in FIG. 2).

In operation S102, a feature perception process is performed on the output sequence of the target information to obtain a target sequence of the target information, wherein the target sequence represents semantic information of each target object in the target information correlated to other target objects in the target information.

Specifically, an embodiment of the disclosure adopts an attention mechanism-based attention model to perform the feature perception process on the output sequence of the target information. Wherein for the output sequence of the target information, the attention model can be used to learn an associated target vector for each target vector in the output sequence. Where, for example, when sentence processing is conducted, the target vector may be a word vector and the target object may be a word included in the sentence. For example, when image processing is conducted, the semantic information associated between target objects (e.g., pixels) can refer to textures, colors, or the like.

Specifically, the operation S102 above can predict the discrete dominant (non-zero) index of the attention matrix in an end-to-end manner by a sparse attention matrix estimation module as shown in FIG. 2, and then effectively calculate the context-aware vector (i.e., the target sequence of the target information) by performing a series of scattering operations through an attention scattering module as shown in FIG. 2.

Wherein when the above improvements provided by the embodiment of the disclosure is applied to the related models in NPL field, the improvements in operation S102 can adapt to the attention layers. When used in the Transformer model using an encoder-decoder architecture, the improvements can adapt to the attention layers in the architecture.

Specifically, embodiments of the disclosure provide an efficient Transformer architecture that is referred to as Fourier sparse attention for Transformer (FSAT) for performing fast context-awareness. The FSAT model proposed by the embodiments of the disclosure not only reduces the computational complexity, but also improves the accuracy of the model. Specifically, it consists of two core submodules, one is a hidden state crossing module based on the fast Fourier transform, which captures and pools N² semantic terms with the time complexity of O (N logN), the second is the sparse attention matrix estimation module, which predicts the dominant elements of the attention matrix based on the output of the hidden state crossing module. By means of reparameterization and gradient truncation, FSAT can learn the indexes of the dominant elements. The implementation of the disclosure facilitates the reduction of the overall complexity of the sequence length from O (N²) to O (N logN).

Referring to FIG. 2, the processing process of the method according to an embodiment of the disclosure can be a corresponding token vector is determined by looking up a token embedding table for the input content (e.g., the sequence to be encoded, which may be text), then the crossing of a token pair can be implemented by a pooled hidden state crossing module to configure a cross vector, more particularly, a cross vector containing context dependency information, subsequently, based on the cross vector, a sparse attention matrix can be calculated by a sparse attention matrix estimation algorithm, further, the context-awareness (target sequence) of the input sequence can be output through a series of scattering operations based on a predicted sparse attention matrix.

In an embodiment of the disclosure, the improvements involved in the above operations S101 and S102 can be applied to the attention layers of the natural language processing model, such as using the fully connected network of operation S101 as the pre-part of the feature perception layer and using the output of the fully connected network as the input to the feature perception layer. Wherein a fast Fourier transform-based feature crossing method is used in the fully connected network to improve the crossing process of two hidden states in the related art, and a predictable sparse attention mechanism is used in the feature perception to improve the attention mechanism in the related art to reduce the computational complexity of the model.

Hereinafter, illustration will be made with respect to the specific processing process for the crossing of hidden states in an embodiment of the disclosure.

In an embodiment of the disclosure, hidden state crossing is performed on the target vector in the input sequence of the target information based on the various considered factors below: (1) the hidden state crossing is a method for extracting second-order token features with which can generate more expressive feature representations, (2) the hidden state crossing can capture the dependencies of far away semantics and facilitate the task of sequence transduction, (3) the hidden state crossing is performed depth-wisely and can be implemented by fast Fourier transform.

In an embodiment of the disclosure, considering that a process can be perform by a fully connected network or a depth-wisely separable convolution network when achieving the crossing of at least two hidden states, the hidden state vectors Xi and Xj are respectively multiplied in terms of elements by a parameterized non-linear feature mapping function to obtain a hidden state after crossing. Specifically, it is based on a given input sequence [\vec{x₀}, . . . , \vec{x_{N-1}}], and please refer to the following Equation 1.

\vec{c}ᵢⱼ=f₁(\vec{x}ᵢ)⊙f₂(\vec{x}ⱼ) Equation 1

In Equation 1, \vec{x}ᵢ is a vector representation corresponding to a token I, \vec{x}ⱼ is a vector representation corresponding to a token j, f1(·)and f2(·)are parameterized non-linear feature mapping functions (their parameters correspond to a first learnable parameter matrix and a second learnable parameter matrix respectively), ⊙ is a

Hadamard product (multiplied by elements), and C_{i,j} is a crossed state of the token I and the token j. \vec{cᵢⱼ} is a vector representation corresponding to the crossed state of the token I and the token j, wherein the learnable parameter matrices follow the training of the model and the values of the elements (parameters) in the parameter matrices will change adaptively.

Additionally, considering that the pairwise crossing of hidden states is achieved by a fully connected structure, a fully connected process at n² is required if a token sequence with length of n. On the one hand, the computational complexity is relatively high, and on the other hand, n² output vectors are too large to store and use in an attention model. Therefore, the embodiments of the disclosure can adopt a fast Fourier transform-based hidden state crossing algorithm below to achieve the pairwise crossing of hidden states.

In an embodiment of the disclosure, the performing a fast Fourier transform-based feature crossing process on at least two target vectors in an input sequence of target information to obtain an output sequence of the target information in operation S101, includes the following operations A1- A2:

In operation A1, corresponding crossed hidden states are determined based on a feature function for the at least two target vectors in the input sequence of the target information. Wherein the feature function includes a parameterized non-linear feature mapping function f( ).

In operation A1, the crossed hidden states are addressed based on the fast Fourier transform to obtain the output sequence of the target information.

In an embodiment of the disclosure, the determining corresponding crossed hidden states based on a feature function for the at least two target vectors in the input sequence of the target information, includes the following operations A11-A12:

In operation A11, a first sequence and a second sequence are determined based on the input sequence of the target information.

Where it may be understood that the first sequence and the second sequence are vector sequences having same lengths and identical objects (e.g., tokens). Optionally, the first sequence corresponds to a sequence in which the hidden state I is located, and the second sequence corresponds to a sequence in which the hidden state j is located.

In operation A12, the corresponding crossed hidden states are determined based on the feature function for a first target vector in the first sequence and a second target vector in the second sequence, wherein in the feature function, the first target vector is different from the second target vector, and the first target vector corresponds to a first learnable parameter matrix, and the second target vector corresponds to a second learnable parameter matrix.

The operations A11 and A12 will be illustrated by taking the above target information “ [symbol] [symbol] ” as an example.

The following sequences can be determined based on the input sequence [X₁X₂X₃X₄X₅X₆X₇X₈X₉X₁₀] of the target information:

a first sequence [Xᵢ₁Xᵢ₂Xᵢ₃Xᵢ₄Xᵢ₅Xᵢ₆Xᵢ₇Xᵢ₈Xᵢ₉Xᵢ₁₀]; and

a second sequence [Xⱼ₁Xⱼ₂Xⱼ₃Xⱼ₄Xⱼ₅Xⱼ₆Xⱼ₇Xⱼ₈Xⱼ₉Xⱼ₁₀].

or,

a first sequence [X₁X₂X₃X₄X₅X₆X₇X₈X₉X₁₀], i ϵ[1,10]; and

a second sequence [X₁₁X₁₂X₁₃X₁₄X₁₅X₁₆X₁₇X₁₈X₁₉X₂₀], jϵ[11,20].

The above sequences are only taken as an example for distinguishing between the first sequence and the second sequence, and the representation forms of the sequences are not limited in practical application.

Wherein when performing the pairwise feature crossing process of hidden states, one vector is obtained from the first sequence and one vector is obtained from the second sequence for processing.

Specifically, based on the above Equation 1, the calculation form of the k-th output of convolution of the first sequence and the second sequence can be referred to the following Equation 2.

$${\vec{c}}_{k} = {\sum }_{i + j = k} {\vec{c}}_{ij} = {\sum }_{i + j = k} {f}_{1} ( {\vec{x}}_{i} ) ⊙ {f}_{2} ( {\vec{x}}_{j} ) \qquad Equation 2$$

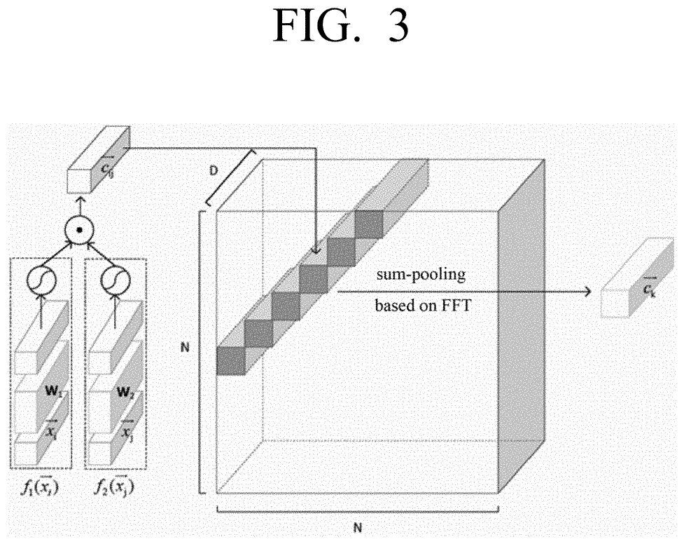

In the above Equation 2, the sequence xi corresponds to the first sequence, and the sequence xj corresponds to the second sequence, cₖ is the summation of the hidden state crossings along the kth anti-diagonal of FIG. 3, therefore the number of the output vectors can be reduced from original value of n²

$$( e . g . , \{ {\vec{c}}_{{IJ}_{i , j ∈ [ 0 , N - 1 ]}} \} )$$

to 2n−1(e.g., {\vec{c}ₖ_{_{kϵ[0,2N−2]}}}).

Optionally, since the product in frequency domain is equivalent to the convolution in the time domain, the expression as shown in above Equation 2 can be addressed by the fast Fourier transform. In this process, the hidden states are first transformed by the non-linear feature mapping function, then a 1-dimension Fourier transform is applied in the dimension of the sequence of the transformed hidden states, which is transformed to frequency domain, and a convolution transform is completed in frequency domain, and at last the crossed and summed hidden states are transformed back from frequency domain. Due to the Hermitian property, the imaginary part of the output is zero, so it is safe to retain only the real input and thus avoid introducing complex numbers into the model.

Specifically, the operation for the crossed hidden states based on the fast Fourier transform to obtain the output sequence of the target information, includes the following operations A13-A15.

In operation A13, a first feature function corresponding to the first target vector and the first learnable parameter matrix is performed based on the fast Fourier transform for real input to obtain a first feature information.

In operation A14, a second feature function corresponding to the second target vector and the second learnable parameter matrix is performed based on the fast Fourier transform for real input to obtain a second feature information. and

In operation A15, a convolution transform of the first feature information and the second feature information is performed based on an inverse fast Fourier transform for real input to obtain the output sequence of the target information.

Specifically, in the operations A13 and A14, after the first feature function and the second feature function are transformed by the non-linear feature mapping function, the sequence of the transformed hidden states is transformed into frequency domain based on the 1D (1-dimension) Fourier transform, and the convolution transform (corresponding to the convolution transform of the first feature information and the second feature information) in completed in the frequency domain, in operation A15, the crossed and summed hidden states are transformed by an inverse 1D Fourier transform in frequency domain, and the output sequence of the target information is finally obtained.

With reference to the operation in the above operations A13-A15, reference can be made to the following Equation 3.

C₀= [symbol] ( [symbol] ⁻¹( [symbol] (f₁(X))⊙ [symbol] (f₂9X)))) Equation 3

In the above Equation 3, X is an input matrix (X ϵRN×D) containing N D-dimension hidden state vectors, F and F⁻¹ represent the fast Fourier transform for real input and the inverse fast Fourier transform for real input respectively, R represent an operation of retaining the real input of the complex number, C₀(C₀ϵR^{(2N-1)×D}) is the hidden state crossing result (e.g., a cross matrix corresponding to the output sequence of the target information) obtained by the operation in the embodiments of the disclosure. Wherein the first feature function corresponds to f₁(X), and the second feature function corresponds to f₂(X).

In the embodiments of the disclosure, the overall computational complexity of the sequence length is reduced from O (N²) to O (N logN).

FIG. 3 is a schematic diagram of a crossing of hidden states according to an embodiment of the disclosure.

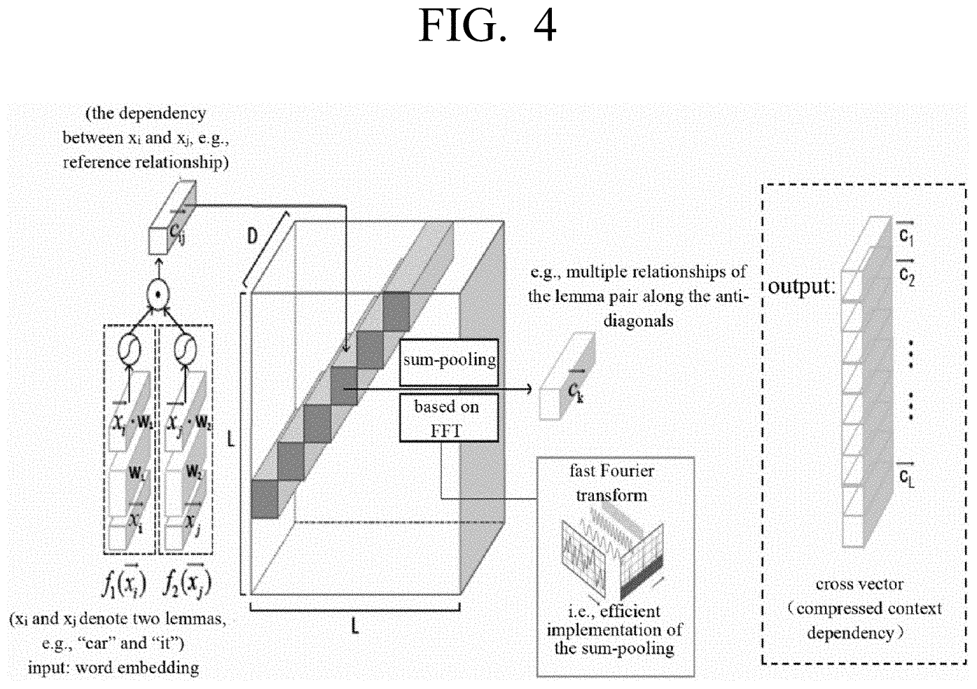

FIG. 4 is a schematic diagram of a flow for pooled hidden state crossing according to an embodiment of the disclosure.

In an embodiment of the disclosure, for a combination of each target vector pair (it may be a token pair when the target object to be processed is a word), a long-term semantic dependency and a correlation can be captured by hidden state crossing (capturing semantic correlations is also the basis for the predictable sparse attention mechanism). For the case where the hidden states are crossed and pooled depth-wisely, this can be efficiently achieved by the fast Fourier transform. Specifically, FIG. 4 is a process flowchart of the pooled hidden state crossing module as shown in FIG. 2.

Referring to FIG. 4, in an embodiment of the disclosure, an embedded vector for each token (i.e., a word) of the input sequence is transformed by the non-linear feature mapping function f(·) and then the crossing of the token pairs is achieved by multiplying between every two tokens by elements, generating the vector C_{i,j}, and after that all token pairs can form a tensor having a size of L*L*D, wherein L may be the sequence length, and D is the dimension of the vector. Based on this, the cross vector ck can be generated by performing a sum-pooling along the anti-diagonals, wherein the sum-pooling operation along the anti-diagonals can reduce the situations of information confusion and can be quickly and effectively implemented by FFT, and then all the resultant cross vectors constitute the output of the module and the output contains contextual semantic dependencies.

Hereinafter, the specific content of the hidden state crossing algorithm based on the convolution of the fast Fourier transform in the embodiments of disclosure will be illustrated in matrix form in conjunction with FIG. 3.

Referring to FIG. 3, it may be an n×n matrix (the length of the input sequence of the target information is n), and the element in i-th row and j-th column represents the hidden state crossing of the token i and the token j, the result of the addition of the elements through which the k-th anti-diagonal passes in the form of an anti-diagonal. The addition result on all n anti-diagonals constitutes the final output (that may be output in the form of a matrix, and in the disclosure may be referred to as a cross matrix), i.e., the hidden states after crossing.

Hereinafter, illustration will be made with respect to the specific procedure for the feature perception process in an embodiment of the disclosure.

In a feasible embodiment of the disclosure, the performing a feature perception process on the output sequence of the target information in operation S102, includes the following operations S1021-S1022:

In operation S1021, the same element values are deleted in a cross matrix corresponding to the output sequence of the target information; the element values are hidden states after pairwise crossing of the target vectors;

In operation S1022, the feature perception process is performed on the cross matrix with the same element values deleted.

Specifically, as can be seen from the above Equation 3, it includes 2n−1 vectors, which is twice of the sequence length. The length needs to be reduced in order to keep the computational complexity from increasing for subsequent feature perception based on the attention mechanism. Accordingly, an embodiment of the disclosure provides improvements based on central token symmetry.

Referring to FIG. 3, the addition along the anti-diagonals produces a combination of tokens (crossing) that are symmetrical about the central token. Specifically, in even diagonals, the central token is the k/2-the token, e.g., the combination of tokens of the 10th diagonal includes 5-5, 4-6, 3-7, and so on. In odd diagonals, the center of symmetry is between the k/2-th downward rounding and the k/2-th upward rounding, e.g., the combination of tokens of the 11th includes 5-6, 4-7, 3-8, and so on. Therefore, the embodiments of the disclosure can reduce the length by merging the adjacent even and odd anti-diagonals. In the above example, the 10th and the 11th anti-diagonals are added together. In addition, a combination consisting of two identical tokens, e.g., the combination of tokens 5-5, is subtracted. Specifically, the expression can be shown as following Equation 4.

C=LN(C₁+C₂−f₁(X)⊙f₂(X) Equation 4

wherein C₁(a row of zeros is supplemented to align with the length of C₂) and Cₗare the odd row and even row of the matrix C₀ respectively. LN represents layer normalization operations to ensure stable training, and C is the output matrix (i.e., the resultant matrix after deleting the same element values in the cross matrix C₀). Wherein C₁ϵR^{N×D}, C₂ϵR^{N×D}, and CϵR^{N×D}.

In FIGS. 3, w1 and w2 are the parameters of f1(x) and f2(x) respectively.

In a feasible embodiment of the disclosure, considering that the sparsity of the attention matrix does not mean that all token pairs (combinations of tokens, i.e., crossings of hidden states) are correlated, an embodiment of the disclosure integrates a gating mechanism into the hidden state crossing to reflect the property. The hidden state crossing after integration may be referred to as gated hidden state crossing.

Specifically, the performing a feature perception process on the output sequence of the target information in operation S102, includes the following operation S1023 :

In operation S1023, the feature perception process is performed on hidden states of a target vector pair having correlation in the output sequence of the target information, the target vector pair are pairwise target vectors for which the feature crossing have been performed.

Specifically, the target vector pair having correlation is also the gated hidden state crossing, and its specific definition can be expressed as shown in the following Equation 5.

\vec{g}ᵢⱼ=σ₁(\vec{x}ᵢ)⊙σ₂(\vec{x}ⱼ) Equation 5

In the above Equation 5, σ( ) is a parameterized gating function, and the subscripts 1 and 2 means that different parameters are contained. The gated hidden state is cᵢⱼ⊙gᵢⱼ, wherein gᵢⱼ is used to control the degree of correlation and information throughput of two tokens (target vector). In order to avoid confusion in understanding by redefining the preceding equation, embodiments of the disclosure integrate the gating mechanism by defining the following feature mapping function, as expressed in Equation 6 below.

f(\vec{x})=τ(\vec{x})⊙σ(\vec{x}) Equation 6

In the above equation, τ( ) is a parameterized non-linear function, and in an embodiment of the disclosure a 1-layer fully connected network or a depth-wisely separable convolution network are used as the parameterized function. Optionally, an ELU activation function and a sigmoid activation function can be used as the non-linear feature mapping function and the gating function respectively.

Specifically, considering that in the attention mechanism used in the related art, a complete attention matrix of size n² needs to be calculated for target information of sequence length n, the computational complexity is high and squared with the sequence length, an embodiment of the disclosure proposes that operation for the sparse matrix form of the attention matrix by only calculating the dominant elements (non-zero elements) in the attention matrix to reduce the computational complexity. Specifically, the computational complexity is reduced from O (n²) to O (n logn), and the computation process is derivable, more particularly, can be learned automatically by learning algorithms.

In an embodiment of the disclosure, the performing a feature perception process on the output sequence of the target information in operation S102, includes the following operation B1:

In operation B1, the feature perception process is performed on dominant elements in a cross matrix corresponding to the output sequence of the target information, wherein the dominant elements include non-zero elements.

Wherein the cross matrix may be the output result of the operation S101, that is, the hidden states after crossing. In operation B 1, the feature perception process is performed based on the hidden states after crossing, which facilitates the increase of the accuracy rate of the semantic information determined by context modelling models. Wherein the feature perception can be processed based on pre-constructed attention model.

Optionally, operation B1 may also be the feature perception process based on at least one of the embodiments corresponding to the operations S1021-S1022 and the embodiment corresponding to the operation S1023. For example, when the feature perception process is performed on the dominant elements in the cross matrix in operation B1, the cross matrix may refer to the cross matrix corresponding to the output sequence output by the operation S101, may also be a matrix with the same element values deleted, and may also refer to a matrix of hidden state of a target vector pair having correlation.

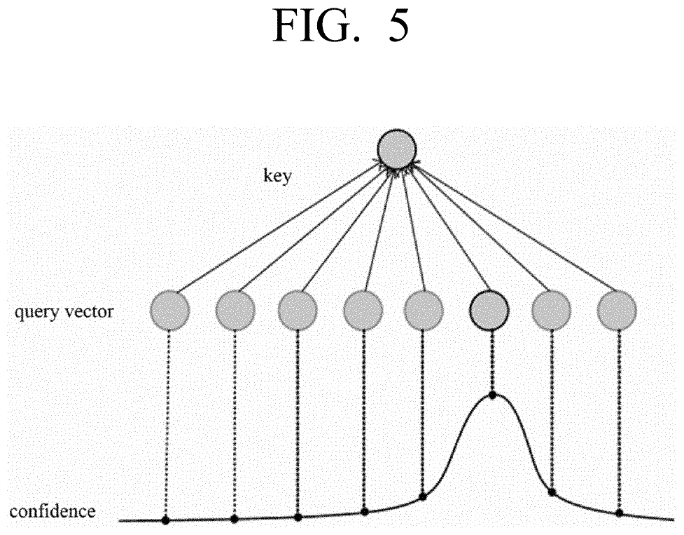

FIG. 5 is a schematic diagram of a computation process for a predictable sparse attention mechanism according to an embodiment of the disclosure.

Referring to FIG. 5, the specific procedure for the feature perception process will be illustrated in conjunction with a schematic diagram of the computation process for the predictable sparse attention mechanism.

In an embodiment of the disclosure, the performing the feature perception process on dominant elements in a cross matrix corresponding to the output sequence of the target information to obtain a target sequence of the target information in operation B1, includes the following operations B11-B13:

In operation B11, column indexes of the dominant elements in the cross matrix corresponding to the output sequence of the target information is determined.

Specifically, the key to make the sparse attention matrix predictable is to make the predicted discrete indexes derivable, and an embodiment of the disclosure proposes a dominant index matrix (consisting of column indexes of the non-zero elements) to reparameterize the discrete indexes. Specifically, the column index I of the predicted non-zero elements is calculated by the following Equation 7-1.

\vec{I}=σ(CW_{I}+\vec{b}_{I})·Nₘₐₓ Equation 7-1

In the above Equation 7-1, W_{I} and b_{I} are a learnable weight and an offset value, W_{I}ϵR^{D×N}, \vec{b}₁ϵR^{M}, σ represents a sigmoid activation function, and Nmax is the maximum length supported by the model, and C is the cross matrix. For example, if the maximum length is 2000 and the predicted Iₖ may be 135, it is indicated that the 135-th column of the k-th row of the sparse attention matrix is a non-zero element. Since a key vector may have a plurality of dominant query vectors, the disclosure assumes the maximum number of the dominant query vectors by a hyper-parameter M.

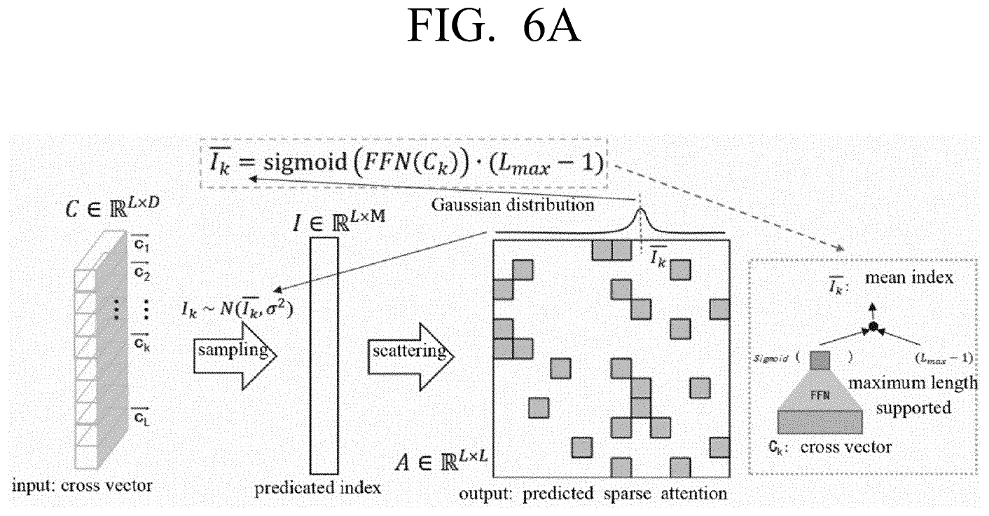

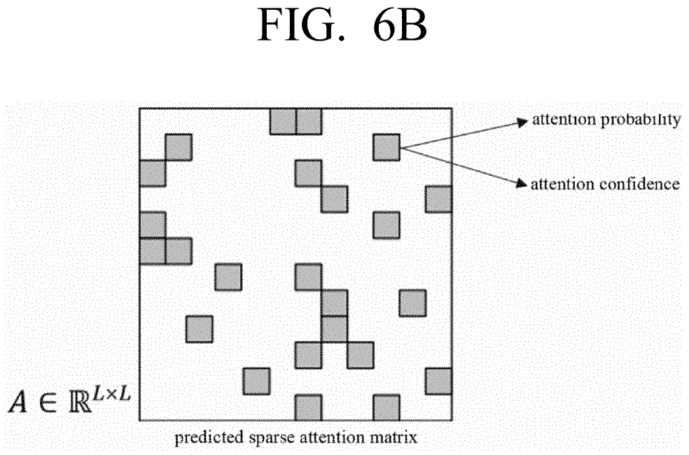

FIG. 6A is a schematic diagram of a flow of generating a predicted sparse attention matrix according to an embodiment of the disclosure.

Referring to FIG. 6A, when obtaining the output sequence of the target information (the input cross vector as shown in FIG. 6A), in addition to being calculated by the above Equation 7-1, the mean index \vec{I}ₖ of each cross vector can also be calculated by the following Equation 7-2.

Wherein when obtaining the output sequence of the target information (the input cross vector as shown in FIG. 6A), in addition to being calculated by the above Equation 7-1, as shown in FIG. 6A, the mean index \vec{I}ₖ of each cross vector can also be calculated by the following Equation 7-2:

\vec{I}ₖ=sigmoid(FFN(Cₖ))·(Lₘₐₓ−1) Equation 7-2

In the above Equation 7-2, k is the k-th row of the matrix. Lₘₐₓ is the maximum length supported by the model, sigmoid together with FFN is an activation function, and Cₖis a cross vector.

Specifically, the process for finding which elements in the attention matrix are dominant (non-zero) without calculating the complete attention matrix will be illustrated in conjunction with FIG. 6A.

First, for the input cross vector, the mean index \vec{I}ₖ of each cross vector is calculated by the above Equation 7-2, which means that the k-th of the attention matrix follows Gaussian distribution having a mean value of \vec{I}ₖ , and then M indexes Iₖ are sampled from Gaussian distribution according to the predicted mean value and a hyper-parameter variance Γ², the hyper-parameters (e.g., M and Γ²) can be determined by a crossing verification. Base on this, the index can be obtained, e.g., an index (k, Iₖ) which means a dominant element at the k-th row and the Iₖ-th column, and then the pattern of the sparse attention matrix can be predicted according to the predicted elements with scattered indexes.

In order to assist the model to learn about the sparse attention matrix, an embodiment of the disclosure introduce an attention confidence. Specifically, the definition of the confidence of the j-th query vector on the k-th key vector can be expressed as the Equation 8 shown below:

s_{j→i}= [symbol] (j|\vec{I}ᵢ, σ²) Equation 8

Wherein N represents Gaussian distribution, and Iᵢ is the index of the dominant query vector (IϵN^{N×M}), the key vector is attended by the dominant query vector with a dominant attention score (e.g., an edge Iᵢ−>i corresponds to a dominant element in the attention matrix). σ² is a hyper-parameter representing variance. The definition of the above Equation 8 is based on the observation that query vectors away from a dominant query vector have decreasing probability of attention to the key vector.

Specifically, given a sparse graph described by an index matrix I, where Iᵢⱼ denotes that there is a directed edge from the Iᵢⱼ-th query vector to the i-th key vector, the confidence of each edge can be calculated according to the following Equation 9.

s_{I}_{ᵢⱼ}→i= [symbol] (Iᵢⱼ|\vec{I}ᵢⱼ, σ²) Equation 9

Wherein Iᵢⱼ is the j-th dominant index of the i-th key vector. Thus, through the chain rule of gradients, the gradient of confidence can be continuously passed from the loss function to the matrix C.

In operation B12, a confidence of the sparse matrix is determined based on the column indexes, and obtaining the sparse attention matrix based on the confidence of the sparse matrix and an attention probability matrix.

Specifically, the index matrix I determines which edges in the sparse graph are considered and which are ignored. Two types of index matrices may be involved in an embodiment of the disclosure, one is predicted index matrix Iₚ=[I], the other one is a random index matrix Iᵣ˜U(0,N−1). The process for learning the sparse matrix can be regarded as a process for searching for correct indexes, which is a process of exploring new knowledge and utilizing existed knowledge. Therefore, the union of two index matrices Iₚ and Iᵣ may be used in model training, and only predicted index matrix Iₚ may be used in reasoning test.

Specifically, after obtaining the column indexes of the non-zero elements in each row, the sparse matrix (may also be referred to as sparse attention matrix) can be configured by the column indexes. A predictable sparse attention method can be explained by a weighted directed sparse graph, wherein the N query/key vectors for the input sequence are included, the directed edge therebetween denotes the attention of a head node on a tail node, and two weights (attention probability and confidence) are provided for each edge. The attention matrix is the adjacent matrix of the graph. Then the i-th output of the sparse attention is calculated by the following Equation 10-1.

$${𝒜 ( X , C )}_{i} = ( {\prod }_{h = 1}^{H} ( Ψ ( \frac{{\vec{q}}_{i}^{h} {K}_{{N}_{i}^{h}}^{{h}^{T}}}{\sqrt{d}} ) ⊙ {\vec{s}}_{i \to {N}_{i}^{h}}^{h} ) {V}_{{N}_{i}^{h}}^{h} ) {W}_{o} \qquad Equation 10 - 1$$

In the above Equation 10-1, qᵢ is a query vector, K and V are a key matrix and a value matrix mapped from C and X respectively, d is the vector dimension of each head, ψ( ) is a softmax function, and Π operation indicates that the results of h heads calculation are concatenated together by dimension, and Nᵢ is a set of neighboring nodes of the i-th node. When Nᵢ is located at the location of the subscript, it is indicated that only the row corresponding to the node in Nᵢ in the matrix are extracted, sᵢ−>Ni denotes a confidence score corresponding to an edge on which the node i points to the node in Nᵢ, which corresponds to a multi-head attention mechanism and a plurality of head independent calculations, and the superscript h denotes the head sequence number in the multi-head attention. Wherein querying the matrix in an embodiment of the disclosure may mean finding the elements appearing in each row of the matrix for the constructed sparse matrix.

Wherein corresponding to the above Equation 10-1, the query matrix Q, key matrix K, and value matrix V of the h-th head can be obtained by the following expression:

Q^{h}=XW_{Q}^{h}, k^{h}=CW_{L}^{h}, V^{h}=CW_{V}^{h}

FIG. 6B is a structural schematic diagram of a predicted sparse attention matrix according to an embodiment of the disclosure.

Referring to FIG. 6B, when the index of the matrix is obtained through operation B11, the attention probability and attention confidence are padded for each predicted dominant element (as shown in FIG. 6B), which is expressed specifically in the following Equation 10-2.

$$A = softmax ( \frac{{( {QC}^{T} )}_{I}}{\sqrt{d}} ) \cdot N ( {I}_{k} , \overline{{I}_{k}} , {σ}^{2} ) \qquad Equation 10 - 2$$

In Equation 10-2,

$$softmax ( \frac{{( {QC}^{T} )}_{I}}{\sqrt{d}} )$$

is an attention probability, i.e., the probability that the i-th token is correlated to the j-th token, and N(Iₖ, \vec{Iₖ}, σ²) is an attention confidence, i.e., the confidence that a matrix element is a dominant element. Specifically, in the embodiments of the disclosure, the attention confidence is introduced to enable automatic learning of the sparse structure of the attention matrix, wherein the confidence of the i-th query vector and the j-th key vector is defined as the value of the predicted Gaussian distribution.

In the embodiments of the disclosure, the attention probability in Equation 10-2 corresponds to a standard attention matrix, when the attention confidence is introduced to enable automatic learning of the sparse structure of the attention matrix, i.e., a reparameterization process is introduced by which the index prediction becomes learnable.

In operation B13, the target sequence of the target information is determined based on the sparse attention matrix.

Specifically, the semantic information of each token in the target sequence correlated to other token can be determined by the above Equation 10-1.

In an embodiment of the disclosure, the operation of performing a feature perception process on the dominant elements in the cross matrix corresponding to the output sequence of the target information to obtain a target sequence of the target information is performed based on a pre-constructed attention model. When the attention model is trained, a gradient truncation is performed on a back-transferred positive gradient, and wherein the back-transferred gradient is determined by a loss value of the model and a mean value of the column indexes. The key to make the sparse attention matrix predictable is to perform the back propagation of the gradient by the predicted discrete indexes. In an embodiment of the disclosure, the discrete indexes are reparameterized by the multiplying the attention probability with the attention confidence. Therefore, learning the discrete indexes becomes differentiable, and learning can be performed in an end-to-end manner

Wherein the back transfer algorithm, also called back propagation algorithm, can be understood as an algorithm that calculates the gradient of the model parameters based on the loss function Loss and updates the model parameters. The back transfer algorithm can be iterated by repetitive cycle of two segments (excitation propagation, weight update) until the network response to the input reaches a predetermined target range. Wherein the gradient is a derivative vector of the loss function with respect to the parameters.

In an embodiment of the disclosure, in order to achieve a learnable solution for the above feature perception computation process, it is considered that since a positive gradient in confidence reduces the confidence values on the edges in a gradient descent algorithm, this means that the gradient prevents the model from considering these edges in sparse attention and adjusts the model parameters to change the predicted dominant indexes. However, due to the discreteness of the indexes, changing the predicted dominant indexes to be larger or smaller does not guarantee an approximation to the correct dominant indexes. Conversely, a negative gradient indicates a hit on the correct dominant indexes, and therefore, an embodiment of the disclosure sets the model to be adjusted by a negative gradient.

Specifically, when the attention model is trained, gradient truncation is performed on the gradients of the back transfer algorithm, i.e., the positive gradient of the mean value of the column indexes is truncated.

Specifically, it is shown in the following Equation 11.

$$grad ( \overline{{I}_{k}} ) = \{ \begin{matrix}\frac{dLoss}{d \overline{{I}_{k}}} , & \frac{dLoss}{d \overline{{I}_{k}}} < 0 \\ 0 , & \frac{dLoss}{d \overline{{I}_{k}}} \geq 0\end{matrix} \qquad Equation 11$$

In the above Equation 11, Loss is the loss of the model, and gad(\vec{Iₖ}) represents a partial derivative of the model loss Loss with respect to the variable \vec{I}ₖ.

In a feasible embodiment of the disclosure, the improvements of the hidden state crossing proposed by an embodiment of the disclosure for the above embodiments applies for the process for modifying the self-attention model. Optionally, corresponding to the above Equation 10-1, when the sparse attention mechanism is not used, the Equation 10-1 may be expressed as the Equation 12 below:

$$𝒜 ( X , C ) = ( {\prod }_{h = 1}^{H} Ψ ( \frac{{Q}^{h} {K}^{{h}^{T}}}{\sqrt{d}} ) {V}^{h} ) {W}_{o} \qquad Equation 12$$

In the above Equation 12, d is the vector dimension of a single dimension, the superscript h denotes the head sequence number in the multi-head attention, Π operation indicates that the results of H heads calculation are concatenated together by dimension, ψ( ) is a softmax function, and W₀ϵR^{Hd×D} is an output mapping matrix. Wherein in the embodiments of the disclosure, respective modifications are made to the query vector, key and value, and for details, see the expressions corresponding to various parameters below the above Equation 10-1.

Specifically, in order to adapt to the above operation S102, when the feature perception process is performed directly based on the output sequence of the target information while the sparse attention mechanism is not used, processing can be based on what is shown in the above Equation 12.

Hereinafter, illustration will be made with respect to the improvements of complexity in an embodiment of the disclosure.

The predictable sparse attention mechanism proposed by the embodiments of the disclosure has lower computation cost in time and memory usage.

Specifically, the computational complexity of the hidden state crossing includes the feature mapping O (ND²) and the fast Fourier transform O (ND logN). The computational complexity involved in the above Equation 10-1 includes calculating the attention probability O (NMD), calculating the attention confidence O (NDM), and a matrix multiplication O (NMD+ND²) of the value matrix and the mapping matrix. The overall computational complexity is O (ND²+ND logN+NMD). Since M is generally very small, e.g., M=4, for a long sequence, the computational complexity is much smaller than O (N²D+ND²). In terms of memory usage, a whole attention matrix is not needed to be stored for the sparse attention, thus the memory complexity is reduced from O (N²H) to O (NMH).

In the embodiments of the disclosure, in view of the high complexity of the matrix multiplication, an effective algorithm by scattering the attention is provided. The algorithm can maintain a sparse pattern having fine granularity, i.e., a token-level granularity, thus ensuring both high accuracy and efficiency.

In a feasible embodiment of the disclosure, the determining the target sequence of the target information based on the sparse attention matrix in operation B13, includes operations of B131-B132:

In operation B131, an element vector is determined based on the dominant elements selected from the sparse attention matrix and a corresponding value vector,

In operation B132, a scatter add operation for the element vector is performed based on the indexes of the selected dominant elements to determine the target sequence of the target information.

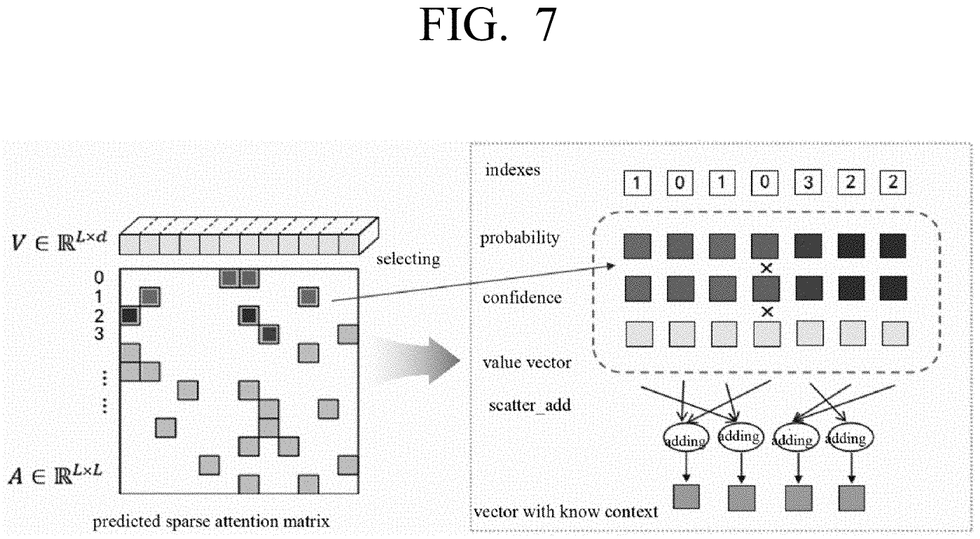

FIG. 7 is a schematic diagram of a flow for determining a context-aware vector according to an embodiment of the disclosure.

Referring to FIG. 7, the processing process for the algorithm includes the dominant elements are selected from a predicted sparse attention matrix and multiplied by the value vector to obtain the element vector, and the scatter_add operation is performed on the value vector obtained in operation B131 according to the indexes of the selected elements, and further, a context-aware vector is (i.e., the target sequence) is output.

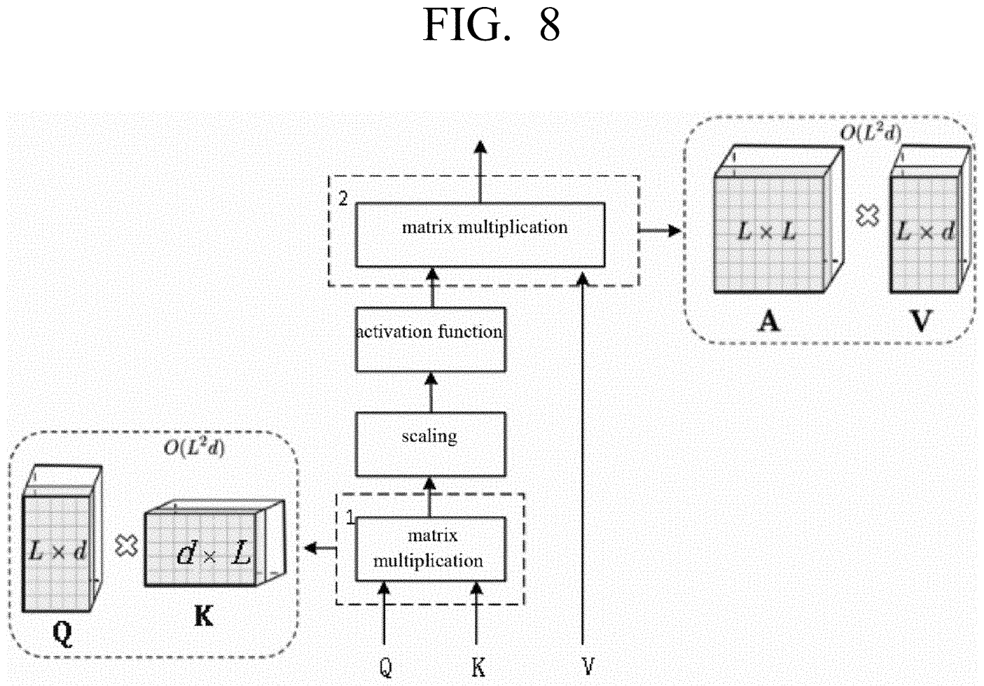

Hereinafter, the improvements to the attention mechanism in the embodiments of the disclosure is illustrated in conjunction with FIG. 8.

FIG. 8 is a schematic diagram of a processing process for an attention mechanism according to an embodiment of the disclosure.

Referring to FIG. 8, a processing process for the attention mechanism is shown. Where Q, K, and V denote query, key, and value vectors respectively, and are embedded projections of the input sequence, d is the number of tensor dimensions, L is the length of the input sequence, and A is the attention matrix.

In an embodiment of the disclosure, considering that the computational complexity between Q and K for the process of matrix multiplication MatMul is quadratic (squared level) of length L, and the quadratic computation need to consume a large amount of computational time and space cost for long sequences, and the processing of long sequences is prone to loss of information, resulting in lower accuracy of the processing results, therefore optimization is carried out for the matrix multiplication part shown in dashed box 1 in FIG. 8. Specifically, the matrix multiplication part shown in dashed box 1 is optimized by sparse attention matrix estimation as well as pooled hidden state crossing, e.g., by adjusting the quadratic calculation to a log-linear calculation to reduce the computational complexity and increase the accuracy of the processing results.

In addition, the disclosure also considers that the computational complexity between A and V for the process of matrix multiplication MatMul is also quadratic (squared level) of length L, the same problem of consuming a large amount of computational time and space costs for long sequences exists, the matrix multiplication part shown in dashed box 2 is optimized by a scattered attention mechanism, such as adjusting the quadratic calculation to a linear one, in order to reduce the computational complexity.

The following provides an example of a feasible application of the information processing method provided by an embodiment of the disclosure, in order to provide a specific description of effects that can be achieved by the embodiment of the disclosure.

Specifically, the improvements involved in the above embodiments of the disclosure are substituted into the training process of the Transformer model. Wherein the model input can take the form of a sequence in the ListOps data, i.e., the input sequence of the target information, in the form of the sequence is as follows.

[MAX 4 3[MIN 2 3]1 0[MEDIAN 1 5 8 9, 2]]

The sequence is a string of mathematical expressions of nested structure and the processing objective of the model is to output the result of the operation of this mathematical expression (the output of the model is 5). The maximum sequence length is 2000.

In an application example, the Transformer model is used to handle the above-mentioned tasks and the attention layer in the Transformer is improved by the method proposed in the embodiments of the disclosure.

In one embodiment of the disclosure, the technical solutions provided in the embodiments of the cation are also applicable to low computing power devices.

For the case of low computing power devices, due to the limited computing power, taking into account problems, such as the time delay and memory usage, the object of the embodiment of the disclosure is to reduce the computation cost of the existing attention mechanism-based models.

The process for working on low computing power devices is as follows.

1. The computing power is identified.

Different devices may have different computing power, which can be measured by the number of basic computing operations per second (ops). For example, a cleaning robot may have a computing power of about 500M ops, and a smartphone has a computing power of about 1 to 10T ops.

Memory usage is measured by the size of the model in RAM, for example a limit of 200 KB on a cleaning robot and 10 MB on a smailphone.

2. The key hyper-parameters that affect the time delay and memory usage of the model are limited/adjusted.

The key hyper-parameters that affect the time delay and memory usage of the model include the number of vector dimensions D, the number of layers N, the maximum sequence length L, the number of attention heads H and the number of index samples M.

The time delay of the model can be estimated as O(NLD²+NLDlog L+NLMD).

Memory usage can be estimated as O(NLMH+NLD).

For example, a device with a computing power of about 500M ops should have a value of less than 5M for the equation O(NLD²+NLDlog L+NLMD) in order for the model to respond to a user request within 100 milliseconds. In this case, the key hyper-parameters can be set a D=32, N=1, L=512, and M=4. H can be set to 2 if the amount of the memory usage is set as no more than 200 KB.

M and L are determined online, and the other hyper-parameters are determined offline

3. A user request is received for obtaining the embedded vector for input tokens.

The user request may be characters/subwords/words/pixel sequences, or the like. Each character/subword/word/pixel is regarded as a token. By looking up the embedded vector tablet, the embedded vector of the input tokens can be obtained.

If the length of the sequence requested by the user exceeds the maximum sequence length L, the model processes at most L tokens at a time and performs the following processing operations multiple times separately.

4. Context-aware vectors are generated through a multi-layer neural network model, with each layer performing the following processes.

a. The cross vector is calculated by the pooled hidden state crossing module.

The input token vector is used as an input, and the semantic dependencies of token pairs are efficiently calculated using a fast Fourier transform-based algorithm.

The key hyper-parameters involved in this module are the number of vector dimensions D, the number of layers N, the maximum sequence length L, and the number of attention heads.

b. The sparse attention matrix is estimated based on the cross vector.

The key hyper-parameters involved in this module are the number of vector dimensions D, the number of layers N, the maximum sequence length L, the number of attention heads H, and the number of index samples M.

c. The attention output is calculated effectively through the scattering operations.

The key hyper-parameters involved in this module are the number of vector dimensions D, the number of layers N, the maximum sequence length L, the number of attention heads H, and the number of index samples M.

d. The token-level semantic features are extracted through a fully connected layer.

The key hyper-parameters involved in this module are the number of vector dimensions D, the number of layers N and maximum sequence length L.

5. The attention output of the last layer is returned as the final context-aware vector.

The implementation of the disclosure can effectively reduce computation cost (as shown in the equation mentioned in operation 2) and can therefore be applied to low computing power devices. In addition, the above process can be applied to both low computing power devices and high computing power servers. The difference is that different devices use different key hyper-parameters, more particularly the maximum sequence length L and the number of index samples M. For devices with high computing power, L and M can be set to larger values. For devices with low computing power, L and M are smaller.

Embodiments of the disclosure are also compatible with scenarios where multiple AI models work. Embodiments of the disclosure are related to the processing of the efficient attention model, as the attention model itself is compatible with scenarios where multiple AI models work and therefore the embodiments of the disclosure are also compatible. When multiple requests are requested by the user, the above process will be repeated several times, each request is processed individually on a single-threaded device, for a multi-threaded device, the requests are distributed to multiple processing units (e.g., CPU cores, GPU cores) and the above processes are executed in parallel.

Table 1 below shows the validation results of the improved model proposed in embodiments of the disclosure on the Listops dataset, with the Transformer model used as the baseline model for performance comparison, the results are as follows.

TABLE 1

| | accuracy rate |
|---|---|
| prior art | 37.3 |
| the present application | 46.5 |

From what is shown in Table 1 above, it can be seen that the model proposed in embodiments of the present application has greatly improved the accuracy rate.

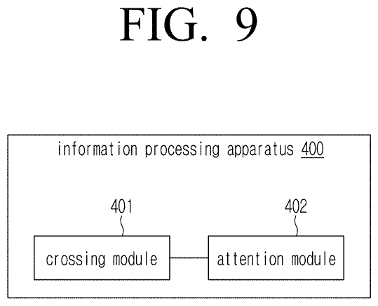

FIG. 9 is a schematic structure diagram of an information processing apparatus according to an embodiment of the disclosure.

Referring to FIG. 9, an embodiment of the disclosure provides an information processing apparatus 400, which may include a crossing module 401 and an attention module 402.

Wherein the crossing module 401 is configured for performing a fast Fourier transform-based feature crossing process on at least two target vectors in an input sequence of target information to obtain an output sequence of the target information, and the attention module 402 is configured for performing a feature perception process on the output sequence of the target information to obtain a target sequence of the target information, wherein the target sequence represents semantic information of each target object in the target information correlated to other target objects in the target information.

In an embodiment of the disclosure, the crossing module 401, when configured for performing a fast Fourier transform-based feature crossing process on at least two target vectors in an input sequence of target information to obtain an output sequence of the target information, is specifically configured for: determining corresponding crossed hidden states based on a feature function for the at least two target vectors in the input sequence of the target information, and addressing the crossed hidden states based on the fast Fourier transform to obtain the output sequence of the target information, wherein the feature function includes a parameterized non-linear feature mapping function.

In an embodiment of the disclosure, the crossing module 401, when configured for determining corresponding crossed hidden states based on a feature function for the at least two target vectors in the input sequence of the target information, is specifically configured for: determining a first sequence and a second sequence based on the input sequence of the target information, and determining the corresponding crossed hidden states based on the feature function for a first target vector in the first sequence and a second target vector in the second sequence, wherein the first target vector is different from the second target vector, in the feature function, the first target vector corresponds to a first learnable parameter matrix, and the second target vector corresponds to a second learnable parameter matrix.

In an embodiment of the disclosure, the crossing module 401, when configured to address the crossed hidden states based on the fast Fourier transform to obtain the output sequence of the target information, is specifically configured to perform a first feature function corresponding to the first target vector and the first learnable parameter matrix based on the fast Fourier transform for real input to obtain a first feature information, performing a second feature function corresponding to the second target vector and the second learnable parameter matrix based on the fast Fourier transform for real input to obtain a second feature information and performing a convolution transform of the first feature information and the second feature information based on an inverse fast Fourier transform for real input to obtain the output sequence of the target information.

In an embodiment of the disclosure, the attention module 402, when configured for performing a feature perception process on the output sequence of the target information, is specifically configured for deleting the same element values in a cross matrix corresponding to the output sequence of the target information, the element values are hidden states after crossing of the at least two target vectors, and performing the feature perception process on the cross matrix with the same element values deleted.

In an embodiment of the disclosure, the attention module 402, when configured for performing a feature perception process on the output sequence of the target information, is specifically configured for performing the feature perception process on hidden states of a target vector pair having correlation in the output sequence of the target information, the target vector pair are the target vectors for which the feature crossing have been performed.

In an embodiment of the disclosure, the attention module 402, when configured for performing a feature perception process on the output sequence of the target information, is specifically configured for performing the feature perception process on dominant elements in a cross matrix corresponding to the output sequence of the target information, wherein the dominant elements include non-zero elements.

In an embodiment of the disclosure, the attention module 402, when configured for performing the feature perception process on dominant elements in a cross matrix corresponding to the output sequence of the target information to obtain a target sequence of the target information, is specifically configured for determining column indexes of the dominant elements in the cross matrix corresponding to the output sequence of the target information, determining a confidence of the sparse matrix based on the column indexes, and obtaining the sparse attention matrix based on the confidence of the sparse matrix and an attention probability matrix determination, and determining the target sequence of the target information based on the sparse attention matrix.

In an embodiment of the disclosure, the operation of performing a feature perception process on the output sequence of the target information to obtain a target sequence of the target information is performed based on a pre-constructed attention model, when the attention model is trained, a gradient truncation is performed on a back-transferred positive gradient, and wherein the back-transferred gradient is determined by a loss value of the model and a mean value of the column indexes.

In an embodiment of the disclosure, the attention module 402, when configured for determining the target sequence of the target information based on the sparse attention matrix, is specifically configured for: determining an element vector based on the dominant elements selected from the sparse attention matrix and a corresponding value vector, and performing a scatter_add operation for the element vector based on the indexes of the selected dominant elements to determine the target sequence of the target information.

The apparatus according to embodiments of the disclosure can perform the methods according to embodiments of the disclosure, and the implementation principles thereof are similar The actions to be performed by each module in the apparatus according to various embodiments of the disclosure correspond to the operations in methods according to various embodiments of the disclosure. The functional description for various modules of the apparatus can specifically refer to the above description in corresponding method and will not be repeated here.

Embodiments of the disclosure provide an electronic device including a memory, a processor and computer programs stored on the memory, the above-mentioned computer programs are executed by the processor to implement the operations of the information processing method. As compared with the prior art, the following can be achieved by the disclosure an output sequence of target information can be obtained by performing a fast Fourier transform-based feature crossing process on at least two target vectors in an input sequence of the target information, wherein the target vector is also referred to as a hidden state. That is, the crossing of hidden states is implemented, and the relationship between a target vector and another target vector in the target information can be determined. A fully connected process at square level needs to be performed for the implementation of the crossing of hidden states in the related art, which have very high computational complexity. While the disclosure adopts a hidden state crossing method of fast Fourier transform, the crossing of hidden states can be implemented efficiently, which is beneficial to reduce the computational complexity and increase the processing efficiency. On this basis, the target sequence of the target information is obtained by performing a feature perception process on the output sequence of the target information. It is possible to effectively improve the accuracy of the semantic information of each target object the target information represented by the target sequence correlated to other target objects in the target information.

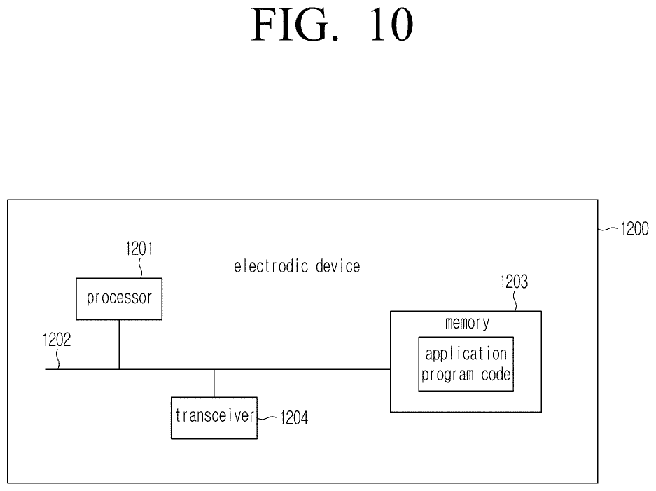

FIG. 10 is a structural schematic diagram of an electronic device according to an embodiment of the disclosure.

Referring to FIG. 10, an electronic device 1200 is provided. The electronic device 1200 as shown in FIG. 10 includes a processor 1201 and a memory 1203. Wherein the processor 1201 is connected with the memory 1203, for example, through a bus 1202. Optionally, the electronic device 1200 may further include a transceiver 1204, and the transceiver 1204 may be used for data interaction between the electronic device and other electronic devices, such as data transmission and/or data reception and so on. It should be noted that in practical applications, the number of the transceivers 1204 is not limited to one, and the structure of the electronic device 1200 does not constitute a limitation to the embodiments of the disclosure.

The processor 1201 may be a central processing unit (CPU), a general-purpose processor, a digital signal processor (DSP), an application-specific integrated circuit (ASIC), a field programmable gate array (FPGA) or other programmable logic devices, transistor logic devices, hardware components, or any combination thereof. It may implement or execute the various logical blocks, modules and circuits described in connection with this disclosure. The processor 1201 may also be a combination for realizing computing functions, such as a combination including one or more microprocessors, a combination of a DSP and a microprocessor, and so on.

The bus 1202 may include a path to transfer information between the components described above. The bus 1202 may be a peripheral component interconnect (PCI) bus or an extended industry standard architecture (EISA) bus and so on. The bus 1202 may be divided into an address bus, a data bus, a control bus, and so on. For ease of presentation, only one thick line is shown in FIG. 10, but it does not mean that there is only one bus or one type of bus.

The memory 1203 may be a read only memory (ROM) or other types of static storage devices that may store static information and instructions, a random access memory (RAM) or other types of dynamic storage devices that may store information and instructions, it may also be electrically erasable and programmable read only memory (EEPROM), a compact disc read only memory (CD-ROM) or other optical disk storage, optical disk storage (including compressed compact disc, laser disc, compact disc, digital versatile disc, blu-ray disc, or the like), magnetic disk storage media, other magnetic storage devices, or any other medium capable of carrying or storing computer programs and capable of being read by a computer, without limitation therein.

The memory 1203 is used for storing a computer program for executing the embodiments of the disclosure, and the execution is controlled by the processor 1201. The processor 1201 is used to execute the computer program stored in the memory 1203 to implement the operations shown in the foregoing method embodiments.

Wherein the electronic device includes but not limited to smartphones, tablets, laptops, smart speakers, smart watches, on-vehicle equipments, or the like.

Embodiments of the disclosure provide a computer readable storage medium having computer programs stored thereon, and the computer programs, when executed by a processor, may implement the operations and corresponding contents of foregoing method embodiments.

Embodiments of the disclosure further provide a computer program product including computer programs, and the computer programs, when executed by a processor, may implement the operations and corresponding contents of foregoing method embodiments.

In an embodiment provided by the disclosure, a method of estimating the position gesture of the above-mentioned device performed by the electronic device may be performed using an artificial intelligence model.

According to an embodiment of the disclosure, when the method is executed in the electronic device, an output data identifying images or image features in an image can be obtained by using image data or video data as the input data of an artificial intelligence model. The artificial intelligence model can be obtained by training. Here, “obtaining by training” means that the basic artificial intelligence model is trained by multiple pieces of training data through a training algorithm to obtain a predefined operation rule or artificial intelligence model configured to execute desired features (or objectives). The artificial intelligence model may include a plurality of neural network layers. Each of the plurality of neural network layers includes a plurality of weight values, and neural network calculation is executed by calculating the result of calculation of the previous layer and the plurality of weight values.

Visual understanding is a technique for recognizing and processing objects in a manner similar to that of human vision and includes, for example, object recognition, object tracking, image searching, human recognition, scene understanding, 3D reconstruction/localization or image enhancement.

The information processing apparatus provided by the disclosure may implement at least one of the multiple modules through an AI model. The AI-associated functions can be executed by a non-volatile memory, a volatile memory and a processor.

The processor may include one or more processors. At this time, the one or more processors may be general-purpose processors, (e.g., central processing unit (CPU), application processor (AP), or the like), or pure graphics processing units, (e.g., graphics processing unit (GPU)), a vision processing unit (VPU), and/or an AI-specific processor, (e.g., a neural processing unit (NPU)).

The one or more processors control the processing of input data according to predefined operating rules or artificial intelligence (AI) models stored in non-volatile memory and volatile memory. Predefined operating rules or artificial intelligence models are provided through training or learning.

Here, providing by learning means that the predefined operation rule or AI model with desired characteristics is obtained by applying a learning algorithm to multiple pieces of learning data. The learning may be executed in an apparatus in which the AI according to the embodiments is executed, and/or may be implemented by a separate server/system.

The AI model may consist of a plurality of neural network layers. Each layer has a plurality of weights, and the calculation in one layer is executed by using the result of calculation in the previous layer and a plurality of weights of the current layer. Examples of neural networks include, but are not limited to, convolutional neural networks (CNN), deep neural networks (DNN), recurrent neural networks (RNN), restricted boltzmann machines (RBM), deep belief networks (DBN), bidirectional recurrent deep neural networks (BRDNN), generative adversarial networks (GAN), and Deep Q-Networks.

A learning algorithm is a method of training a predetermined target device (e.g., a robot) using a plurality of learning data to cause, allow or control the target device to make determinations or predictions. Examples of the learning algorithm include, but are not limited to, supervised learning, unsupervised learning, semi-supervised learning, or reinforcement learning.

It should be understood that, although each operation is indicated by arrows in the flowcharts of the embodiments of the disclosure, the implementation order of these operations is not limited to the order indicated by the arrows. Unless explicitly stated herein, in some implementation scenarios of the embodiments of the disclosure, the implementation operations in each flowchart may be performed in other orders as required. Further, part or all of the operations in each flowchart are based on actual implementation scenarios, and may include a plurality of sub-operations or a plurality of stages. Part or all of these sub- operations or stages may be executed at the same moments, and each sub-step or stage of these sub-operations or stages may also be executed at different moments, respectively. In scenarios with different execution moments, the execution order of these sub-operations or stages may be flexibly configured according to requirements, which is not limited in this embodiment of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An information processing method, the method comprising:
performing a fast Fourier transform-based feature crossing process on at least two target vectors in an input sequence of target information to obtain an output sequence of the target information; and
performing a feature perception process on the output sequence of the target information to obtain a target sequence of the target information,
wherein the target sequence represents semantic information of each target object in the target information correlated to other target objects in the target information.

2. The method of claim 1,
wherein the performing of the fast Fourier transform-based feature crossing process on the at least two target vectors in the input sequence of target information to obtain the output sequence of the target information comprises:
determining corresponding crossed hidden states based on a feature function for the at least two target vectors in the input sequence of the target information, and
determining the crossed hidden states based on the fast Fourier transform to obtain the output sequence of the target information, and
wherein the feature function comprises a parameterized non-linear feature mapping function.

3. The method of claim 2,
wherein the determining of the corresponding crossed hidden states based on the feature function for the at least two target vectors in the input sequence of the target information comprises:
determining a first sequence and a second sequence based on the input sequence of the target information, and
determining the corresponding crossed hidden states based on the feature function for a first target vector in the first sequence and a second target vector in the second sequence, and
wherein the first target vector is different from the second target vector; in the feature function, the first target vector corresponds to a first learnable parameter matrix, and the second target vector corresponds to a second learnable parameter matrix.

4. The method of claim 3, wherein the determining of the crossed hidden states based on the fast Fourier transform to obtain the output sequence of the target information comprises:
performing a first feature function corresponding to the first target vector and the first learnable parameter matrix based on the fast Fourier transform for real input to obtain a first feature information;
performing a second feature function corresponding to the second target vector and the second learnable parameter matrix based on the fast Fourier transform for real input to obtain a second feature information; and
performing a convolution transform of the first feature information and the second feature information based on an inverse fast Fourier transform for real input to obtain the output sequence of the target information.

5. The method of claim 1, wherein the performing of the feature perception process on the output sequence of the target information comprises:
deleting a same element values in a cross matrix corresponding to the output sequence of the target information, the element values being hidden states after crossing of the at least two target vectors; and
performing the feature perception process on the cross matrix with the same element values deleted.

6. The method of claim 1, wherein the performing of the feature perception process on the output sequence of the target information comprises:
performing the feature perception process on hidden states of a target vector pair having correlation in the output sequence of the target information, the target vector pair being the target vectors for which the feature crossing have been performed.

7. The method of claim 1,
wherein the performing of the feature perception process on the output sequence of the target information comprises:
performing the feature perception process on dominant elements in a cross matrix corresponding to the output sequence of the target information, and wherein the dominant elements include non-zero elements.

8. The method of claim 7, wherein the performing of the feature perception process on the dominant elements in the cross matrix corresponding to the output sequence of the target information to obtain the target sequence of the target information comprises:
determining column indexes of the dominant elements in the cross matrix corresponding to the output sequence of the target information;
determining a confidence of a sparse matrix based on the column indexes, and obtaining a sparse attention matrix based on the confidence of the sparse matrix and determination of an attention probability matrix; and
determining the target sequence of the target information based on the sparse attention matrix.

9. The method of claim 8,
wherein the performing of the feature perception process on the output sequence of the target information to obtain the target sequence of the target information is performed based on a pre-constructed attention model,
wherein, when the attention model is trained, a gradient truncation is performed on a back-transferred positive gradient, and
wherein the back-transferred gradient is determined by a loss value of the attention model and a mean value of the column indexes.

10. The method of claim 8, wherein the determining of the target sequence of the target information based on the sparse attention matrix comprises:
determining an element vector based on the dominant elements selected from the sparse attention matrix and a corresponding value vector; and
performing a scatter_add operation for the element vector based on the column indexes of the selected dominant elements to determine the target sequence of the target information.

11. An information processing apparatus, the apparatus comprising:
a crossing module configured to perform a fast Fourier transform-based feature crossing process on at least two target vectors in an input sequence of target information to obtain an output sequence of the target information; and
an attention module configured to perform a feature perception process on the output sequence of the target information to obtain a target sequence of the target information,
wherein the target sequence represents semantic information of each target object in the target information correlated to other target objects in the target information.

12. The apparatus of claim 11, wherein the attention module is further configured to:
delete a same element values in a cross matrix corresponding to the output sequence of the target information, the element values being hidden states after crossing of the at least two target vectors, and
perform the feature perception process on the cross matrix with the same element values deleted.

13. The apparatus of claim 11, wherein attention module is further configured to:
perform the feature perception process on hidden states of a target vector pair having correlation in the output sequence of the target information, the target vector pair being the target vectors for which the feature crossing have been performed.

14. An electronic device comprising:
one or more processors;
a memory; and
one or more computer programs,
wherein the one or more computer programs are stored in the memory and configured to be executed by the one or more processors, and
wherein the one or more computer programs are configured for performing the method according to claim 1.

15. At least one non-transitory computer readable storage medium for storing computer instructions, the computer instructions, when running on a computer, cause the computer to perform the method according to claim 1.

16. A computer program product, comprising computer programs or instructions that, when executed by one or more processors, implement steps of the above information processing the method of claim 1.
